(19) United States
(12) Patent Application Publication
(10) Pub. No.: US 2015/0113114 A1
(43) Pub. Date: Apr. 23, 2015

(54) NETWORK INTERFACE ADAPTER REGISTRATION METHOD, DRIVER, AND SERVER

(71) Applicant: Huawei Technologies Co., Ltd., Shenzhen (CN)

(72) Inventors: Xiaofeng Zhang, Hangzhou (CN); Lijun Li, Hangzhou (CN)

(21) Appl. No.: 14/584,597

(22) Filed: Dec. 29, 2014

Related U.S. Application Data
(63) Continuation of application No. PCT/CN2013/073952, filed on Apr. 9, 2013.

(30) Foreign Application Priority Data
Aug. 7, 2012 (CN) 201210278136.X

(51) Int. Cl. H04L 12/24

(52) U.S. Cl. CPC H04L 41/20
USPC 709/223

(57) ABSTRACT

The present invention provides a network interface adapter registration method, driver, and server, where the method includes: registering, by a driver of a server, a network interface adapter with a kernel of the server as a physical network device; and registering, by the driver, apart of or all hardware queue receiving and sending groups of the network interface adapter with the kernel of the server as virtual network devices, where the physical network device is configured to manage the network interface adapter and all the virtual network devices, and each of the virtual network devices is configured to receive or send data of an application or a chip in the server. The foregoing method resolves a problem in the prior art that management and a direct operation cannot be performed on a single hardware queue of the network interface adapter.

### CROSS-REFERENCE TO RELATED APPLICATIONS

This application is a continuation of International Application No. PCT/CN2013/073952, filed on Apr. 9, 2013, which claims priority to Chinese Patent Application No. 201210278136.X, filed on Aug. 7, 2012, both of which are hereby incorporated by reference in their entireties.

### TECHNICAL FIELD

The present invention relates to communications technologies, and in particular, to a network interface adapter registration method, driver, and server.

### BACKGROUND

Among virtualization technologies, a software virtualization technology first appears. However, because certain resource overhead is caused by software virtualization, software virtualization is gradually developed into hardware-assisted virtualization, which greatly improves virtualization performance. In the virtualization field, virtualization of a central processing unit (Central Processing Unit, CPU for short) and a memory has been relatively mature. In comparison, virtualization of an input/output port (input/output, I/O for short) and a network starts relatively late, and is not so mature currently.

In the network field, development goes from a conventional single-queue network interface adapter (also called network interface card), through a multi-queue network interface card, and to a multi-queue network interface card that supports hardware virtualization. The multi-queue network interface card has multiple receiving and sending queues, and data can be received and sent at the same time, which improves network performance. To better support the virtualization technologies, a function of distributing a data packet is transferred from a virtual machine monitor (Virtual Machine Monitor, VMM for short) to a chip, and therefore a multi-queue network interface card that supports virtualization appears.

Some chip manufacturers have their own network virtualization technologies, for example, virtual machine device queue (Virtual Machine Device Queue, VMDq for short) virtualization and single root input/output virtualization (Single Root IOV, SR-IOV for short). A VMDq network interface card contains multiple hardware queues; the network interface card distributes a data packet received to different hardware queues according to a medium access control (Medium Access Control, MAC for short) address or a virtual local area network identity (Virtual Local Area Network Identity, VLAN ID for short). When data needs to be sent to a network by using the network interface card, a virtual machine selects, according to a sketch value (for example, a source MAC address, a source VLAN ID, or a corresponding hash value) of the data, a hardware queue to send the data.

Currently, in Linux Kernel Mainline, a driver of the VMDq network interface card registers a network device (net_device) with a kernel, so that the network device performs unified management on all hardware queues of the VMDq network interface card. In the registered network device, each hardware queue corresponds to an abstract, where the abstract manages the hardware queue, and saves description information of a data packet (for example, a sending time stamp of the data packet, and a data packet protocol). Specially, at a VMM layer, there is a softswitch (for example, a L2 Software Switch), where the switch implements mapping between an abstract of a hardware queue and an application in the network device. In this way, the application can receive data from another physical machine in a same local area network. For example, when sending data, the application first sends the data to the softswitch, and then the softswitch selects a physical queue to send the data.

However, the foregoing network device performs unified management on all the hardware queues of the network interface card, and implements the mapping by using the softswitch. As a result, the application cannot manage or directly perform an operation on a single hardware queue. Further, if an error occurs in one of the hardware queues, the entire network interface card may reset, which affects another application service.

### SUMMARY

In view of this, with respect to a defect in the prior art, the present invention provides a network interface adapter registration method, driver, and server to resolve a problem in the prior art that management and a direct operation cannot be performed on a single hardware queue of a network interface adapter.

According to one aspect, a network interface adapter registration method provided by the present invention includes:

registering, by a driver of a server, a network interface adapter with a kernel of the server as a physical network device; and

registering, by the driver, a part of or all hardware queue receiving and sending groups of the network interface adapter with the kernel of the server as virtual network devices which are independent of each other, where

the physical network device is configured to manage the network interface adapter and all the virtual network devices, and each of the virtual network devices is configured to receive or send data of an application or a chip in the server.

According to another aspect, a network interface adapter registration method provided by the present invention includes:

registering, by a driver of a server, all hardware queue receiving and sending groups of a network interface adapter with a kernel of the server as virtual network devices which are independent of each other; and

selecting, by the driver, one virtual network device of the virtual network devices to manage public resources of all the virtual network devices.

According to a third aspect, a driver provided by the present invention includes:

a first registering unit, configured to register a network interface adapter with a kernel of the server as a physical network device; and

a second registering unit, configured to register a part of or all hardware queue receiving and sending groups of the network interface adapter with the kernel of the server as virtual network devices which are independent of each other, where

the physical network device is configured to manage the network interface adapter and all the virtual network devices, and each of the virtual network devices is configured to receive or send data of an application or a chip in a server.

According to a fourth aspect, a driver provided by the present invention includes:

a registering unit, configured to register all hardware queue receiving and sending groups of a network interface adapter with a kernel of a server as virtual network devices which are independent of each other; and

a selecting unit, configured to select one virtual network device of the virtual network devices to manage public resources of all the virtual network devices.

According to a fifth aspect, a server provided by the present invention includes any one of the drivers according to the present invention.

It can be learned from the foregoing technical solutions that, with the network interface adapter registration method, driver, and server provided by embodiments of the present invention, the driver registers a network interface adapter as a physical network device, and registers a part of or all hardware queue receiving and sending groups of the network interface adapter with a kernel of the server as virtual network devices which are independent of each other, thereby enabling the physical network device to manage a virtual network device which is used to receive or send data of an application or a chip in a server, and further resolving a problem in the prior art that management and a direct operation cannot be performed on a single hardware queue of the network interface adapter.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following description show some embodiments of the present invention, and a person of ordinary skill in the art may still derive other drawings from these accompanying drawings without creative efforts.

FIG. 1 is a schematic diagram of data receiving and sending in a network device in a KVM policy;

FIG. 2 is a schematic flowchart of a network interface adapter registration method according to an embodiment of the present invention;

FIG. 3 is a schematic diagram of mapping of a virtual network device according to an embodiment of the present invention;

FIG. 4 is a schematic flowchart of a network interface adapter registration method according to an embodiment of the present invention;

FIG. 5 is a schematic flowchart of a network interface adapter registration method according to an embodiment of the present invention;

FIG. 6 is a schematic diagram of mapping of a virtual network device according to an embodiment of the present invention;

FIG. 7 is a schematic flowchart of a network interface adapter registration method according to an embodiment of the present invention;

FIG. 8A is a schematic structural diagram of a driver according to an embodiment of the present invention;

FIG. 8B is a schematic structural diagram of a driver according to another embodiment of the present invention; and

FIG. 9 is a schematic structural diagram of a driver according to another embodiment of the present invention.

### DETAILED DESCRIPTION

To make the objectives, technical solutions, and advantages of the present invention clearer, the following clearly describes the technical solutions of the present invention with reference to the accompanying drawings in the embodiments of the present invention. Apparently, the following described embodiments are a part of the embodiments of the present invention. Based on the following described embodiments of the present invention, a person of ordinary skill in the art can obtain other embodiments which can solve the technical problem of the present invention and implement the technical effect of the present invention by equivalently altering a part of or all the technical features even without creative efforts. Apparently, the embodiments obtained by means of alteration do not depart from the scope disclosed in the present invention.

For ease of description, in the embodiments of the present invention, a network interface adapter is also called a network interface card, and a hardware queue is called a queue for short.

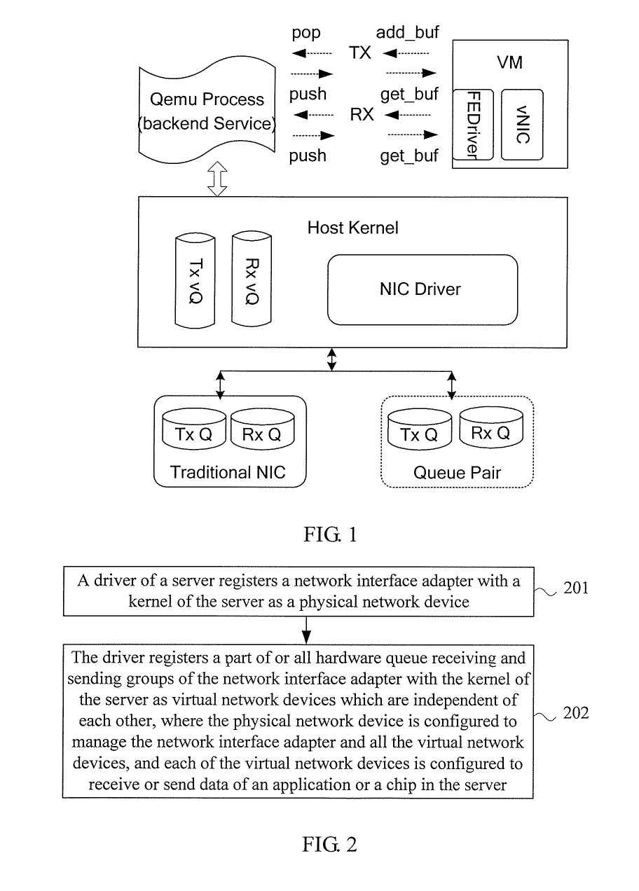

Currently, to resolve a problem that management or an operation cannot be performed on a single queue, in a KVM policy, as shown in FIG. 1, a VMDq network interface card queue is managed independently, and an attempt to achieve compatibility with a conventional single-queue network interface card is also made. A VMDq driver registers a queue of a conventional network interface card or a receiving and sending queue group of a VMDq network interface card with an operating system Dom0 (kernel) as a Vqueue, where the Vqueue is used to shield a hardware difference between the conventional network interface card and the VMDq network interface card.

Meanwhile, a KVM needs to start a qemu process in the Dom0, where this process is a backend service program, and is mainly responsible for interaction work between a virtual machine and a network interface card driver. A frontend network interface card driver is required at a virtual machine end. In a data receiving link, a frontend driver of the virtual machine provides header information and an address of a data packet for the qemu process; the qemu process sends a system call of asynchronous IO, and the system call transfers a request to a network device (such as a network interface card) by using a driver; after the network interface card receives data, the frontend driver sends status information to the qemu process, and the qemu process notifies a corresponding virtual machine according to the header information.

Though the foregoing technology shields the difference between the VMDq network interface card and the conventional network interface card to some extent, a difference between the VMDq network interface card and an SR-IOV network interface card cannot be shielded. Though the foregoing data receiving and sending may implement zero-copy of data, an overall process is complex and asynchronous, and is not applicable to a service scenario with a larger amount of data. In addition, a backend service itself becomes a bottleneck. Further, the foregoing technology uses a frontend and backend mode, where an extra drive is required, and a single correspondence also exists, which is inconvenient for hot migration. That is, when there are multiple types of network interface cards in a server and the virtual machine uses a specific type of network interface card, a particular driver must be used; in this case, hot migration of the virtual machine in the server cannot be implemented.

The present invention provides a network interface adapter registration method. This method implements independent management and operations on a single queue of a network interface adapter by taking advantage of hardware characteristics of a current VMDq network interface card, and reduces mutual influences between queues.

FIG. 2 shows a schematic flowchart of a network interface adapter registration method according to an embodiment of the present invention. As shown in FIG. 2, the following describes the network interface adapter registration method in this embodiment.

201. A driver of a server registers a network interface adapter (also called network interface card) with a kernel of the server as a physical network device.

In this embodiment, the foregoing server kernel is a kernel of an operating system of the server, such as a linux kernel. The foregoing network interface card is a hardware multi-queue network interface card. For example, the foregoing network interface card may be a VMDq network interface card, an intelligent network interface card (iNIC), and/or an SR-IOV network interface card. It should be understood that, VMDq belongs to a first-generation hardware virtualization technology in Intel network virtualization, and SR-IOV belongs to a second-generation hardware virtualization technology in Intel network virtualization.

In this embodiment, the foregoing physical network device may be a network device with a physical function (physical function, PF for short), which is used to manage and maintain the entire network interface card, for example, to apply for an input output (Input Output, IO for short) resource for the network interface card, or to establish a link connection relationship.

202. The driver registers a part of or all hardware queue receiving and sending groups of the network interface adapter with the kernel of the server as multiple virtual network devices which are independent of each other, where the physical network device is configured to manage the network interface adapter and all the virtual network devices, and each of the virtual network devices is configured to receive or send data of an application or a chip in the server.

The foregoing virtual network device may be a network device with a virtual function (virtual function, VF for short), which can receive and send data, complete traffic statistics collection of the network device itself, and complete network link status monitoring, and the like. The network device with a VF in this embodiment has a main function of using a queue to perform data transmission, and also involves some management operations (such as a management operation of responding to the PF).

In this embodiment, the foregoing virtual network devices have their own hardware receiving and sending queue groups, and have a MAC address, an IP address, a VLAN ID, a data receiving and sending process interface, and a management tool interface (such as an ethtool interface), and the like.

It can be learned from the foregoing embodiment that, with the network interface adapter registration method in this embodiment, a driver registers a network interface card as a physical network device, and registers a part of/all hardware queue receiving and sending groups of the network interface adapter with a kernel of the server as virtual network devices, thereby enabling the physical network device to manage multiple virtual network devices which are independent of each other, and further resolving a problem in the prior art that management and a direct operation cannot be performed on a single hardware queue of the network interface adapter.

Further, in the foregoing method, a single physical queue represents a network device in the server. The network device can be directly used by an application or a virtual machine, and a qemu process is not needed any longer, thereby reducing burden of a VMM. Meanwhile, because a network device is presented, and a special frontend or backend driver is no longer required, thereby simplifying a data receiving and sending process, and implementing zero-copy of data.

Certainly, the foregoing method may further shield a hardware difference between physical network interface cards, so that a unified network device interface is presented upwards. For a server, it means that a difference between heterogeneous network interface cards such as a VMDq network interface card, an SR-IOV network interface card, and a conventional single-queue network interface card is shielded, so that an application can be migrated between multiple network devices, that is, hot migration can be implemented.

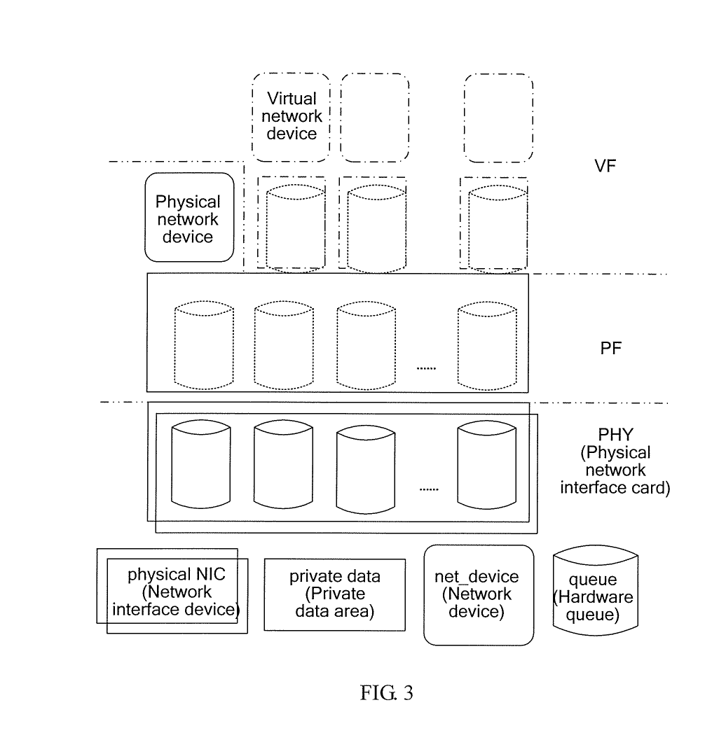

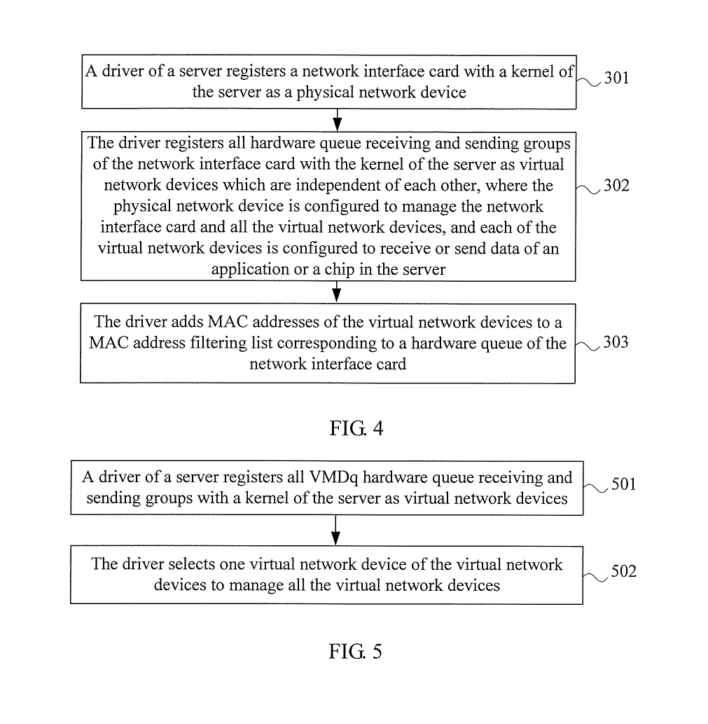

With reference to FIG. 3 and FIG. 4, FIG. 3 shows a schematic diagram of mapping of a virtual network device according to an embodiment of the present invention; and FIG. 4 shows a schematic flowchart of a network interface adapter registration method according to an embodiment of the present invention.

301. A driver of a server registers a network interface card with a kernel of the server as a physical network device.

For example, the foregoing network interface card may be a VMDq network interface card. In addition, the kernel of the server in this embodiment may be a kernel of an operating system of a physical machine, such as a linux kernel.

302. The driver registers all hardware queue receiving and sending groups of the network interface card with the kernel of the server as virtual network devices which are independent of each other, where the physical network device is configured to manage the network interface card and all the virtual network devices, and each of the virtual network devices is configured to receive or send data of an application or a chip in the server.

In a practical application, the number of the foregoing virtual network devices is consistent with the number of the hardware queue receiving and sending groups that support a VMDq function in the network interface card. There is only one physical network device. That is, in the server, a hardware queue receiving and sending group of some network interface cards may not support the VMDq function.

Certainly, in an ideal status, when there is only the VMDq network interface card in the server, the number of the hardware queue receiving and sending groups of the VMDq network interface card is consistent with the number of the virtual network devices.

Each of the foregoing virtual network devices has a function of a conventional network interface card, and each of the virtual network devices can be independently configured and managed. For example, from a perspective of a user, after a virtual network device is started, an IP address is configured for the virtual network device; a MAC address is changed/set; a VLAN ID may further be configured; then, data is sent to the virtual network device; data exchange is performed by using the virtual network device; and information about the network interface card, such as hardware information, a driver version, or a firmware version, is viewed by using an ethtool management tool. In another embodiment, in linux, management and configuration mainly refer to that an operation is performed on a network device by using an ifconfig command and an ethtool command.

303. The driver adds MAC addresses of the virtual network devices to a MAC address filtering list corresponding to a hardware queue of the network interface card.

Alternatively, the driver adds VLAN IDs of the virtual network devices to a VLAN ID filtering list corresponding to the hardware queue of the network interface card.

It may be understood that, when a virtual network device is started, the MAC address of the virtual network device may be added to a MAC address filtering list corresponding to a hardware queue of the network interface card.

The MAC address filtering list herein is consistent with an existing MAC address filtering list, and details are not described in this embodiment.

If a virtual machine in the server uses one of the foregoing virtual network devices to send data, a corresponding virtual network device is selected according to a sketch value (such as a VLAN ID) of the data; and then the virtual network device sends data in a corresponding queue. Because a virtual network device has a MAC address or a VLAN ID, when a physical network device receives a data packet, the data packet contains information about a destination MAC address. In this case, the MAC address is compared with a MAC address in the MAC address filtering list. It is found that the MAC address is consistent with a MAC address in the MAC address filtering list, and the data packet may be distributed to a corresponding hardware receiving queue of the virtual network device according to the destination MAC address or the VLAN ID in the data packet. Therefore, in the foregoing data receiving and sending, a softswitch in the prior art is no longer necessary for implementing queue selection and mapping.

Further, the foregoing network interface adapter registration method further includes step 304, which is not shown in FIG. 4.

304. The driver sets a softswitch in the kernel of the server, where the softswitch is configured to enable multiple virtual machines to perform data interaction between the multiple virtual machines in the server. In this case, data is no longer transmitted, by using a network interface card, between virtual machines in a same server.

That is, a memory area that can be accessed by both a virtual machine and Dom0 is used as a memory for skb data transmission, which can implement zero-copy of data. That is, a softswitch is started in the Dom0; when data exchange is performed between multiple virtual machines in a Dom0 host, processing may be performed by the softswitch, and it is no longer necessary to transfer the data to the physical network device for sending and receiving, which further improves network efficiency.

As shown in FIG. 3, a physical network interface card (such as a VMDq network interface card) that is located at a bottom layer is registered with the kernel of the server as a network device with a PF, that is, a physical network device, where the physical network device manages all queues in the network interface card. After a “PF” is registered successfully, multiple network devices with a VF, that is, virtual network devices, are registered with the kernel of the server according to the number of queues of the VMDq network interface card. Private data of these virtual network devices depends on the “PF”, but each of the virtual network devices corresponds to a specific hardware receiving and sending queue group. The foregoing virtual network devices each have an independent MAC address, IP address, VLAN ID, and the like, have a complete data receiving and sending process, and can complete traffic statistics collection and network link status monitoring separately. A “VF” further has some management tool interfaces, such as an ethtool interface. In this case, a user can view, by using the management tool interfaces, running status of a network, driver information and hardware information of a network device, and the like.

In addition, in FIG. 3, the physical network interface card that is located at the bottom layer has multiple hardware receiving and sending queues. The driver registers a network device (net_device) with a PF with the kernel of the server. A private data area (such as private data in FIG. 3) of the network device with a PF abstracts each of the hardware receiving and sending queues, and the network device with a PF performs unified management on these hardware queues.

After the PF is registered successfully, the driver registers each VMDq hardware queue group with the kernel of the server as a virtual network device (that is, a network device with a VF). A private data area of this VF has a description of only one queue group abstract. This abstract is not obtained by abstracting the hardware queue again, but is obtained by directly mapping the hardware queue into an abstract of the network device with a PF. A queue abstract of each of the virtual network devices maps with a unique queue abstract of the network device with a PF. From a perspective of the virtual network device, it seems like that the virtual network device has an independent queue.

The virtual network device has its own MAC address, IP address, and VLAN ID, and has its own network device operation interface and ethtool interface.

When the VF is enabled, the driver adds the MAC address of the virtual network device to a MAC address filtering list of the physical network device, so that when network data is sent to the MAC address of the virtual network device, the physical network device directly distributes the data to a receiving queue corresponding to the VF. In this way, the VF has a same function as a conventional network interface card.

The foregoing virtual network devices may be used directly in a host of a server, may be used directly by a virtual machine in a bridging or another manner, and may also be used by a specific application or virtual machine after bandwidth is increased by aggregating the virtual network devices by using a technology such as bond.

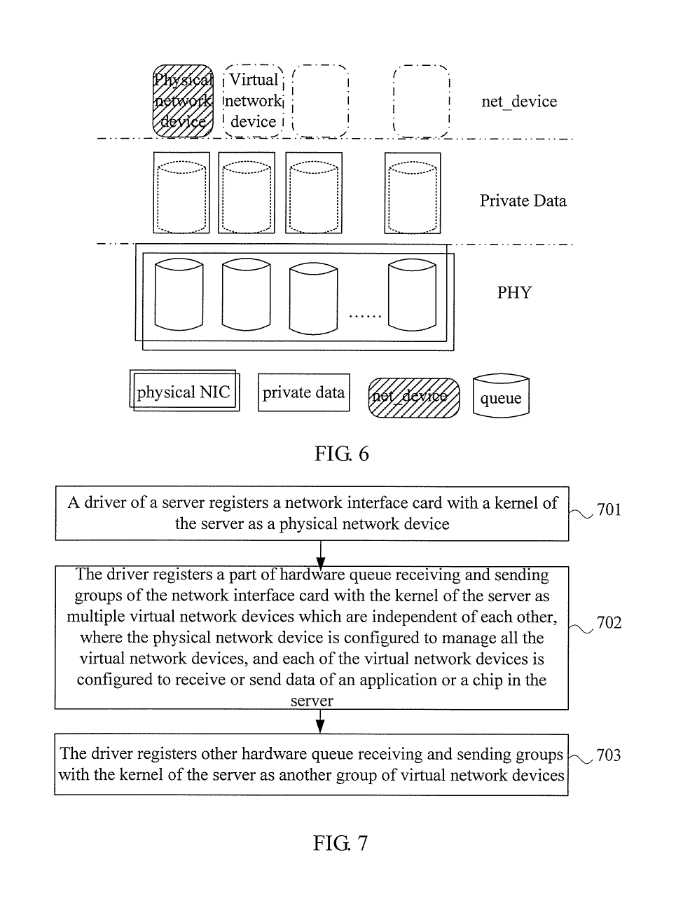

In another application scenario, FIG. 5 shows a schematic flowchart of a network interface adapter registration method according to another embodiment of the present invention; and FIG. 6 is a schematic diagram of mapping of a virtual network device according to an embodiment of the present invention. With reference to FIG. 5 and FIG. 6, the following describes the network interface adapter registration method

501. A driver of a server registers all VMDq hardware queue receiving and sending groups of a network interface adapter with a kernel of the server as virtual network devices.

In this step, each of the virtual network devices has a MAC address, an IP address, a VLAN ID, a data receiving and sending process interface, and a management tool interface.

502. The driver selects one virtual network device of the virtual network devices to manage all the virtual network devices.

Specifically, the foregoing driver selects one virtual network device of the virtual network devices to manage public resources of all the virtual network devices, such as IO information related to the Peripheral Component Interconnect Express (Peripheral Component Interconnect Express, PCIe for short).

A network interface card in this embodiment may be a hardware multi-queue network interface card, such as a VMDq network interface card or an iNIC network interface card.

Currently, multi-queue receiving and sending groups of the network interface card are mutually independent; therefore, each receiving and sending group may be regarded as an independent conventional single-queue network interface card, and the multi-queue receiving and sending groups of the network interface card use a same physical port to connect to an external physical switch. These single-queue groups are separately registered as network devices with a VF, that is, virtual network devices. The virtual network devices have an independent MAC address, an IP address, and a VLAN ID, can independently complete data receiving and sending, and can complete independent traffic statistics collection and status monitoring. A hierarchical structure is shown in FIG. 6.

In FIG. 6, each queue is registered as a virtual network device. A private data area of the virtual network device has a queue abstract, where the abstract describes a queue corresponding to the network device. The driver selects one virtual network device of the virtual network devices (a shadowed virtual network device in FIG. 6) to manage all the virtual network devices.

The registered virtual network devices have a same function and structure as those of the conventional single-queue network interface card. It should be noted that, the queue mentioned herein refers to a queue that supports a VMDq function. In practice, a part of queues of some hardware do not necessarily support the VMDq function.

That is, the virtual network devices each have an independent MAC address, IP address, and VLAN ID, and have an independent data receiving and sending function and management link.

Because each of the virtual network devices has an independent data link and management link, an operation does not affect another virtual network device. However, all network devices share a physical port; therefore, a virtual network device with a “privilege” is required to maintain an entire link, and a virtual network device registered by a queue 0 is usually selected to take over the work.

Preferably, the foregoing network interface adapter registration method further includes step 503, which is not shown in the following FIG. 5.

503. The driver adds MAC addresses of the virtual network devices to a MAC address filtering list corresponding to a network interface adapter.

Alternatively, the driver adds VLAN IDs of the virtual network devices to a VLAN ID filtering list corresponding to the network interface adapter.

In the foregoing network interface adapter registration method, queue receiving and sending groups of a VMDq network interface card is registered as multiple virtual network devices with an independent network function, and each of the virtual network devices corresponds to a unique queue receiving and sending group. Further, a privileged virtual network device exists among the virtual network devices, where the privileged virtual network device manages and maintains the VMDq network interface card. If an error occurs in a virtual network device/queue, the privileged virtual network device maintains the entire VMDq network interface card.

The foregoing virtual network devices may be used directly in a host of a server, may be used directly by a virtual machine in a bridging or another manner, and may also be used by a specific application or virtual machine after bandwidth is increased by aggregating the virtual network devices by using a technology such as bond.

In still another application scenario, FIG. 7 shows a schematic flowchart of a network interface adapter registration method according to another embodiment of the present invention. As shown in FIG. 7, the following describes the network interface adapter registration method in this embodiment.

701. A driver of a server registers a network interface card with a kernel of the server as a physical network device.

702. The driver registers a part of hardware queue receiving and sending groups of the network interface card with the kernel of the server as multiple virtual network devices which are independent of each other, where the physical network device is configured to manage all the virtual network devices, and each of the virtual network devices is configured to receive or send data of an application or a chip in the server.

In this embodiment, the foregoing server kernel may be a kernel of an operating system of a physical machine.

703. The driver registers other hardware queue receiving and sending groups with the kernel of the server as another group of virtual network devices. That is, the driver registers the other hardware queue receiving and sending groups with the kernel of the server as another group of multiple virtual network devices which are independent of each other.

Certainly, the physical network device is also configured to manage the other group of the virtual network devices, and each of the another group of the virtual network devices is configured to receive or send the data of an application or a chip in the server.

In this embodiment, the virtual network devices in step 702 are consistent with the other group of the virtual network devices in step 703 at a user level. The only difference lies in that forming processes of the foregoing virtual network devices are different. For the virtual network device in step 702, abstracting a hardware queue is completed by the physical network device, and the virtual network device only performs mapping once. Virtual network devices in step 703 abstract the hardware queue, but a user only sees a result of the abstracting.

It should be noted that, when there is no physical network device to manage all the virtual network devices, in this case, the driver selects any one of the virtual network devices as a the virtual network device with a quasi-PF so as to manage all public resources of all the virtual network devices. However, if there is a physical network device, it is unnecessary to configure a virtual network device with a PF.

It can be learned from the foregoing embodiment that, the network interface adapter registration method in this embodiment resolves a problem that management and a direct operation cannot be performed on a single hardware queue of the network interface adapter.

In addition, the network interface adapter registration method in this embodiment is mainly applied in a data center. In a case that multiple heterogeneous network interface cards such as a conventional single-queue network interface card, a VMDq network interface card, and an SR-IOV network interface card exist in a server at a large-scale network site, a difference exists in implementation of a capability, a structure, a technology, and the like of different types of network devices, and hot migration cannot be performed directly without any modification to the virtual machine.

In the present invention, a driver directly registers a physical queue of a VMDq network interface card as a virtual network device, and a unified network device interface is presented upwards, which shields a hardware difference at a bottom layer at a driver level. A unified interface and device type are provided upwards, which implements non-differentiated resource management and allocation for a large number of heterogeneous network interface cards.

The driver in the present invention is a device driver in a server, and may also belong to a part of operating system software of the server, and the drive may be implemented by software programming.

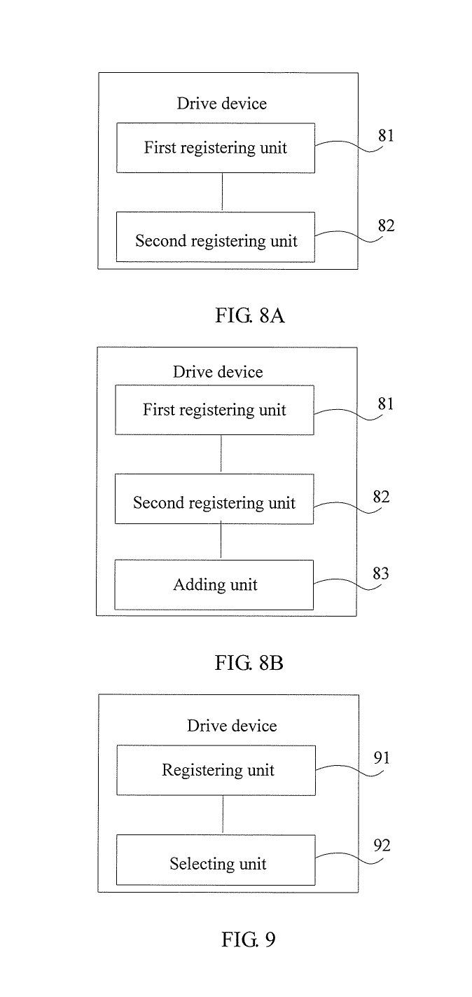

According to another aspect of the present invention, the present invention further provides a driver. As shown in FIG. 8A, the driver in this embodiment includes a first registering unit 81 and a second registering unit 82.

The first registering unit 81 is configured to register a network interface adapter with a kernel of the server as a physical network device; and the second registering unit 82 is configured to register a part of or all hardware queue receiving and sending groups of the network interface adapter with the kernel of the server as virtual network devices which are independent of each other, where

the physical network device is configured to manage the network interface adapter and all the virtual network devices, and each of the virtual network devices is configured to receive or send data of an application or a chip in the server.

In this embodiment, a network interface card may be a hardware multi-queue network interface card, and the network interface card includes a virtual machine device queue VMDq network interface card and an iNIC network interface card.

The foregoing virtual network devices each have a MAC address, an IP address, a VLAN ID, a data receiving and sending process interface, and a management tool interface.

Further, as shown in FIG. 8B, the driver in this embodiment further includes an adding unit 83, where the adding unit is configured to add the MAC addresses of the virtual network devices to a MAC address filtering list corresponding to the network interface adapter, or add VLAN IDs of the virtual network devices to a VLAN ID filtering list corresponding to the network interface adapter.

In addition, the foregoing driver further includes a setting unit (not shown in the figure), where the setting unit is configured to set a softswitch in the kernel of the server, and the softswitch is configured to enable multiple virtual machines to perform data interaction between the multiple virtual machines in the server.

In the present invention, a second registering unit of the driver is adopted to directly register a physical queue of a VMDq network interface card as a virtual network device, and a unified network device interface is presented upwards, which shields a hardware difference at a bottom layer at a driver level. A unified interface and device type are provided upwards, which implements non-differentiated resource management and allocation for a large number of heterogeneous network interface cards.

According to another aspect of the present invention, the present invention further provides a driver. As shown in FIG. 9, the driver in this embodiment includes a registering unit 91 and a selecting unit 92.

The registering unit 91 is configured to register all hardware queue receiving and sending groups of a network interface adapter with a kernel of the server as virtual network devices which are independent of each other; and the selecting unit 92 is configured to select one virtual network device of the virtual network devices to manage other virtual network devices.

Specially, a network interface card may be a hardware multi-queue network interface card, and the network interface card includes a virtual machine device queue VMDq network interface card and an iNIC network interface card.

The foregoing virtual network devices each have a MAC address, an IP address, a VLAN ID, a data receiving and sending process interface, and an ethtool management tool interface.

According to another aspect of the present invention, the present invention further provides a server, and the server includes the driver according to any one of the embodiments of the present invention. For a specific implementation manner of the driver, reference may be made to another apparatus or method embodiment of the present invention, which is not repeatedly described herein. Persons of ordinary skill in the art should understand that, the server provided by this embodiment of the present invention uses the driver provided by the embodiments of the present invention; therefore, an effective effect brought by the driver provided by the embodiments of the present invention may be achieved, that is, a hardware difference at a bottom layer is shielded at a driver level and a unified interface and device type are provided upwards, which implements non-differentiated resource management and allocation for a large number of heterogeneous network interface cards.

Persons of ordinary skill in the art may understand that all or a part of the steps of the method embodiments may be implemented by a program instructing relevant hardware. The program may be stored in a computer readable storage medium. When the program runs, the steps of the method embodiments are performed. The foregoing storage medium includes: any medium that can store program code, such as a ROM, a RAM, a magnetic disk, or an optical disc.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

What is claimed is:

1. A network interface adapter registration method, comprising:
registering, by a driver of a server, a network interface adapter with a kernel of the server as a physical network device; and
registering, by the driver, a part of or all hardware queue receiving and sending groups of the network interface adapter with the kernel of the server as virtual network devices which are independent of each other, wherein
the physical network device is configured to manage the network interface adapter and all the virtual network devices, and each of the virtual network devices is configured to receive or send data of an application or a chip in the server.

2. The method according to claim 1, wherein:
the network interface adapter is a hardware multi-queue network interface adapter; and
the network interface adapter comprises a virtual machine device queue (VMDq) network interface adapter and an intelligent network interface card (iNIC) network interface adapter.

3. The method according to claim 1, wherein each of the virtual network devices has a MAC address, an IP address, a VLAN ID, a data receiving and sending process interface, and a management tool interface.

4. The method according to claim 1, further comprising:
adding, by the driver, MAC addresses of the virtual network devices to a MAC address filtering list corresponding to the network interface adapter, or
adding, by the driver, VLAN IDs of the virtual network devices to a VLAN ID filtering list corresponding to the network interface adapter.

5. The method according to claim 1, further comprising:
setting, by the driver, a softswitch in the kernel of the server, wherein the softswitch is configured to enable multiple virtual machines to perform data interaction between the multiple virtual machines in the server.

6. The method according to claim 1, wherein after registering, by the driver, a part of or all hardware queue receiving and sending groups of the network interface adapter with the kernel of the server as virtual network devices which are independent of each other, the method further comprises:
registering, by the driver, other hardware queue receiving and sending groups of the network interface adapter with the kernel of the server as another group of virtual network devices which are independent of each other.

7. A network interface adapter registration method, comprising:
registering, by a driver of a server, all hardware queue receiving and sending groups of a network interface adapter with a kernel of the server as virtual network devices which are independent of each other; and
selecting, by the driver, one virtual network device of the virtual network devices to manage public resources of all the virtual network devices.

8. The method according to claim 7, wherein:
the network interface adapter is a hardware multi-queue network interface adapter; and
the network interface adapter comprises a virtual machine device queue (VMDq) network interface adapter and an intelligent network interface card (iNIC) network interface adapter.

9. The method according to claim 7, wherein each of the virtual network devices has a MAC address, an IP address, a VLAN ID, a data receiving and sending process interface, and a management tool interface.

10. The method according to claim 7, further comprising:
adding, by the driver, MAC addresses of the virtual network devices to a MAC address filtering list corresponding to the network interface adapter, or
adding, by the driver, VLAN IDs of the virtual network devices to a VLAN ID filtering list corresponding to the network interface adapter.

11. A server, comprising:
a memory; and
a processor coupled with the memory, configured to:
register a network interface adapter with a kernel of the server as a physical network device, and
register a part of or all hardware queue receiving and sending groups of the network interface adapter with the kernel of the server as virtual network devices which are independent of each other, wherein the physical network device is configured to manage the network interface adapter and all the virtual network devices, and each of the virtual network devices is configured to receive or send data of an application or a chip in a server.

12. The server according to claim 11, wherein:
the network interface adapter is a hardware multi-queue network interface adapter; and
the network interface adapter comprises a virtual machine device queue (VMDq) network interface adapter and an intelligent network interface card (iNIC) network interface adapter.

13. The server according to claim 11, wherein each of the virtual network devices has a MAC address, an IP address, a VLAN ID, a data receiving and sending process interface, and a management tool interface.

14. The server according to claim 11, wherein the processor is further configured to:
add MAC addresses of the virtual network devices to a MAC address filtering list corresponding to the network interface adapter, or
add VLAN IDs of the virtual network devices to a VLAN ID filtering list corresponding to the network interface adapter.

15. The server according to claim 11, wherein the processor is further configured to: set a softswitch in the kernel of the server, wherein the softswitch is configured to enable multiple virtual machines to perform data interaction between the multiple virtual machines in the server.

16. A server, comprising:
a memory; and
a processor coupled with the memory, configured to:
register all hardware queue receiving and sending groups of a network interface adapter with a kernel of a server as virtual network devices which are independent of each other, and
select one virtual network device of the virtual network devices to manage public resources of all the virtual network devices.
